(19) United States
(12) Patent Application Publication
(10) Pub. No.: US 2019/0340573 A1
(43) Pub. Date: Nov. 7, 2019

(54) INFORMATION PROCESSING DEVICE

(71) Applicant: Maruichi Warehouse Co., Ltd., Yamanashi (JP)

(72) Inventor: Makoto HORIUCHI, Kofu-shi (JP)

(73) Assignee: Maruichi Warehouse Co., Ltd., Yamanashi (JP)

(21) Appl. No.: 16/343,199

(22) PCT Filed: Oct. 17, 2017
(86) PCT No.: PCT/JP2017/037513

§ 371 Date: Jun. 28, 2019

(30) Foreign Application Priority Data
Oct. 19, 2016 (JP) 2016-205461

(51) Int. Cl. G06Q 10/08; G01C 21/34

(52) U.S. Cl. CPC G06Q 10/08355; G01C 21/343

(57) ABSTRACT

Provided is a feature with which it is possible to successively determine the optimum route of a mobile entity and, as a result thereof, effectively operate a service or the like of keeping goods from a user in custody. A base information management unit 50 retrieves (manages) base information and transmits same to a server 1. A warehouse information management unit 70 retrieves (manages) warehouse information and transmits same to the server 1. A base information retrieval unit 80 retrieves the base information transmitted from a base terminal 2. A warehouse information retrieval unit 81 retrieves warehouse information transmitted from a warehouse terminal 3. A route determination unit 82 determines an optimum route from the base information and warehouse information retrieved by the sever 1 and determines the use information of a user. A use information notification unit 84 transmits the use information determined by the route determination unit 82 to a user terminal 4 in response to a request for use information from a user. A use information presentation unit 123 retrieves use information from the server 1 and appropriately presents the use information to a user.

### TECHNICAL FIELD

The present invention relates to an information processing device.

### BACKGROUND ART

Conventionally, there has been a high demand for a method of efficiently performing physical distribution, and many techniques for the method have been proposed (for example, see Patent Document 1). According to the technology described in Patent Document 1 described above, it is possible to smoothly operate a package distribution system and notify a user of a package delivery status (a current position or the like) in response to an inquiry of the user. For this reason, it is very useful when performing services such as delivering goods to a user.

Patent Document 1: Japanese Unexamined Patent Application, Publication No. 2007-334901

### DISCLOSURE OF THE INVENTION

### Problems to be Solved by the Invention

However, for example, in the case of performing a service of keeping goods such as tires from a user, for example, it is difficult to operate the service efficiently only by notifying the user of a package delivery status. In such a case, it is necessary for the user to efficiently deliver the goods to the service provider and to efficiently receive the goods. In particular, if the goods that the user wishes to deliver are heavy goods such as tires, the goods are often stored once in a warehouse or the like, and it is necessary to take a complicated route.

The present invention has been made in view of such a situation, and an object thereof is to provide a feature with which it is possible to successively determine an optimum route of a mobile entity for transporting goods, and to efficiently operate a service or the like for keeping the goods from a user.

### Means for Solving the Problems

In order to achieve the above purpose, an information processing device according to an aspect of the present invention is

an information processing device which makes a schedule of mobile entities that transport one or more goods via a route including at least one base and one warehouse among a plurality of bases for picking up the goods from a user or delivering the goods to the user and a plurality of warehouses for storing the goods, and the information processing device includes:
a base information retrieval means that retrieves base information including amounts of goods transferred to and from each of the plurality of bases per predetermined unit time; a warehouse information retrieval means that retrieves warehouse information including vacancy situation for each of the plurality of warehouses per predetermined unit time; and a route determination means that determines a route along which each of one or more of the mobile entities travels based on the base information of each of the plurality of bases and the warehouse information of each of the plurality of warehouses.

### Effects of the Invention

According to this invention, it is possible to provide a feature with which an optimum route of a mobile entity can be successively determined and a service or the like of keeping goods from a user can be effectively operated.

### BRIEF DESCRIPTION OF THE DRAWINGS

FIG. 1 is a block diagram illustrating a configuration of an information processing system according to an embodiment of the present invention.

FIG. 2 is a block diagram illustrating a hardware configuration of a server according to an embodiment of the present invention in the information processing system of FIG. 1.

FIG. 3 is a functional block diagram illustrating an example of functional configurations of the server, a base terminal, a warehouse terminal and a user terminal of FIG. 2.

FIG. 4 is a diagram illustrating a specific example of a result of a route determination processing executed by the server of FIG. 3.

FIG. 5 is a view illustrating an example of a screen for presenting use information, which is displayed on the user terminal of FIG. 3.

FIG. 6 is a flowchart describing a flow of a route determination processing executed by the server of FIG. 3.

FIG. 7 is a view illustrating an application example of the route determination processing executed by the server of FIG. 3 and illustrating an example different from the example of FIG. 4.

FIG. 8 is a view illustrating an example of an image on which base information of each base K is displayed within each predetermined period in the route determination processing executed by the server of FIG. 3.

FIG. 9 is a view illustrating an example of a warehouse list used at the time of route determination in a tire deposit route determination processing executed by the server of FIG. 3.

FIG. 10 is a diagram illustrating an example of a result when the number of trucks is one in the tire deposit route determination processing executed by the server of FIG. 3.

FIG. 11 is a view illustrating an example of a result when the number of trucks is two in the tire deposit route determination processing executed by the server of FIG. 3.

### PREFERRED MODE FOR CARRYING OUT THE INVENTION

Hereinafter, embodiments of the present invention will be described using the drawings.

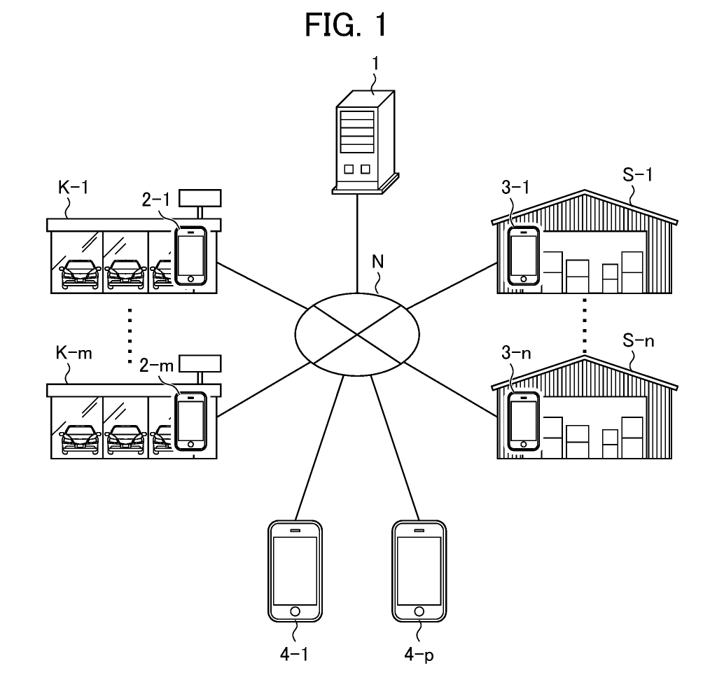

FIG. 1 illustrates a configuration of an information processing system according to an embodiment of the present invention.

The information processing system illustrated in FIG. 1 is applied when providing the following services. That is, the service to which the information processing system according to the present invention is applied is a service which keeps goods such as tires of a user for a predetermined period, in other words, a service in which predetermined goods can be delivered to an arbitrary base, and the predetermined goods can be picked up in an arbitrary base. Although the goods are not particularly limited, for convenience of description, the following description will be made assuming that the goods are tires. In this case, the base is a place such as a dealer or a gas station where tires can be temporarily stored for about several days. The tires delivered by the user to the base are transported to and stored at an arbitrary warehouse, and in a case where the user wishes to pick them up, the tires are transported from the warehouse to an arbitrary base and picked up by the user at the base. In addition, the user can pick up the tires at the same base as the base to which the goods are delivered, but can also pick up the tires at another base. A transport personnel for the goods transports one or more tires along a predetermined route including one or more bases and one or more warehouses, using a predetermined mobile entity (hereinafter, referred to as a truck), and loads and unloads these tires. The information processing system of the present embodiment can determine the optimum route to be taken by the truck under such a service.

As illustrated in FIG. 1, an information processing system according to the present embodiment is configured to include a server 1 managed by a provider of the aforementioned service, base terminals 2-1 to 2-m used by a base manager at each of bases K-1 to K-m at m locations (m is an arbitrary integer value equal to or greater than 1), warehouse terminals 3-1 to 3-n used by a warehouse manager at each of warehouses S-1 to S-n at n locations (n is an arbitrary integer value equal to or greater than 1, which is different from m), and user terminals 4-1 to 4-p used by each of 1 users (1 is an arbitrary integer value equal to or greater than 1, which is different from m and n). The server 1, each of the base terminals 2-1 to 2-m, each of the warehouse terminals 3-1 to 3-n, and the user terminals 4-1 to 4-p are connected to each other via a predetermined network N such as the Internet.

Hereinafter, in a case where it is not necessary to distinguish each of the base terminals 2-1 to 2-m individually, they will be collectively referred to as a “base terminal 2”. Furthermore, hereinafter, in a case where it is not necessary to distinguish each of the warehouse terminals 3-1 to 3-n individually, they are collectively referred to as a “warehouse terminal 3”. Then, hereinafter, in a case where it is not necessary to distinguish each of the user terminals 4-1 to 4-p individually, they are collectively referred to as a “user terminal 4”. Similarly, hereinafter, in a case where it is not necessary to distinguish each of the bases K-1 to K-m individually, they are collectively referred to as a “base K”, and in a case where it is not necessary to distinguish each of the warehouses S-1 to S-n individually, they are collectively referred to as a “warehouse S”.

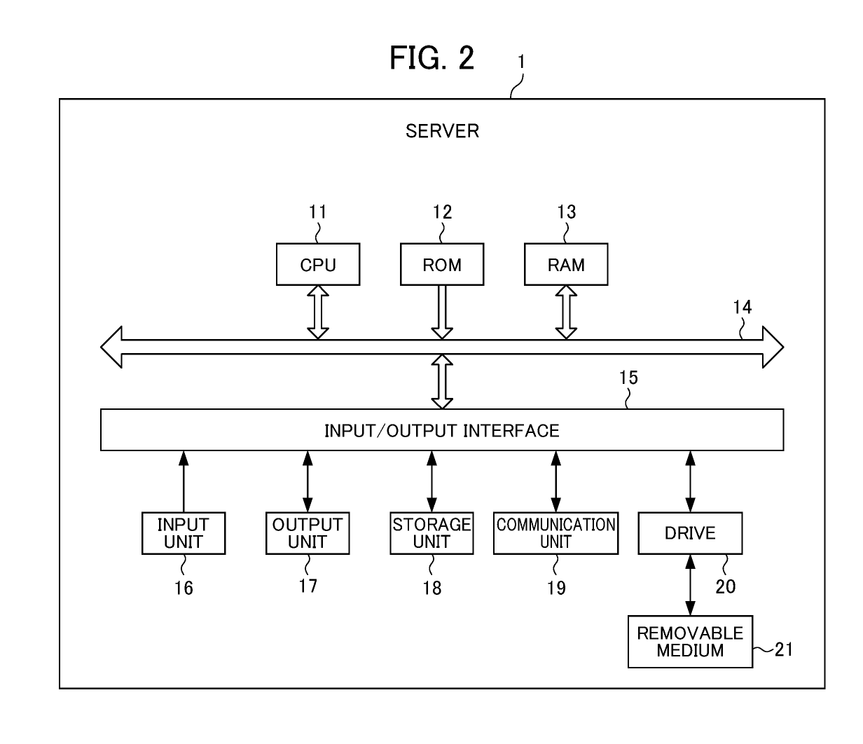

FIG. 2 is a block diagram illustrating a hardware configuration of the server 1 in the information processing system of FIG. 1.

The server 1 includes a central processing unit (CPU) 11, a read only memory (ROM) 12, a random access memory (RAM) 13, a bus 14, an input/output interface 15, an output unit 16, and an input unit 17, a storage unit 18, a communication unit 19, and a drive 20.

The CPU 11 executes various processes in accordance with a program stored in the ROM 12 or a program loaded from the storage unit 18 into the RAM 13. The RAM 13 appropriately stores data and the like necessary for the CPU 11 to execute various processes.

The CPU 11, the ROM 12 and the RAM 13 are connected to one another via the bus 14. The input/output interface 15 is also connected to the bus 14. The output unit 16, the input unit 17, the storage unit 18, the communication unit 19 and the drive 20 are connected to the input/output interface 15.

The output unit 16 is configured by various liquid crystal displays or the like, and outputs various information. The input unit 17 is configured by various hardware lead and the like, and inputs various information. The storage unit 18 is configured by a hard disk, a dynamic random access memory (DRAM), or the like, and stores various data. The communication unit 19 controls communication performed with another device (in the example of FIG. 1, the base terminal 2, the warehouse terminal 3, the user terminal 4, and the like) via a network N including the Internet.

The drive 20 is provided as needed. A removable medium 21 including a magnetic disk, an optical disk, a magneto-optical disk, a semiconductor memory or the like is appropriately installed in the drive 20. The program read from the removable medium 21 by the drive 20 is installed in the storage unit 18 as necessary. The removable medium 21 can also store various data stored in the storage unit 18 in the same manner as the storage unit 18.

The configurations of the base terminal 2, the warehouse terminal 3 and the user terminal 4 are basically the same as the configuration of the server 1, and thus the descriptions thereof are omitted here.

The following series of processing (hereinafter, referred to as a “route determination processing”) can be performed by the cooperation of various hardware and software of the server 1, the base terminal 2, the warehouse terminal 3 and the user terminal 4 of FIG. 2.

That is, each of the base terminals 2-1 to 2-m retrieves information such as entrance and exit information of the tires with respect to each of the bases K-1 to K-m per unit time (for example, one day), and sends the information to the server 1. Such information obtained from the base K, for example, location information of the base K, information according to scheduled time zone for keeping the tires per unit time (for example, one day), information according to scheduled time zone for delivering the tires per unit time (for example, one day) and the like are collectively referred to as “base information” in the following description. The server 1 retrieves base information from each of the base terminals 2-1 to 2-m per unit time (for example, one day).

Each of the warehouse terminals 3-1 to 3-n retrieves information such as entrance and exit information of the tires with respect to each of the warehouses S-1 to S-n per unit time (for example, one day), and sends the information to the server 1. Such information obtained from the warehouse S, for example, location information of the warehouse S, information according to scheduled time zone for receiving the tires per unit time (for example, one day), information according to scheduled time zone for releasing the tires per unit time (for example, one day) and the like are collectively referred to as “warehouse information” in the following description. The server 1 retrieves warehouse information from each of the warehouse terminals 3-1 to 3-n per unit time (for example, one day).

When the server 1 retrieves the base information from each of the base terminals 2-1 to 2-m and the warehouse information from each of the warehouse terminals 3-1 to 3-n, an optimum route (hereinafter, referred to as an “optimum route”) for one or more trucks to transport one or more tires is determined based on the base information and the warehouse information. The optimum route described here is determined based on the information of a predetermined area (for example, within Yamanashi prefecture or the like).

The user terminal 4 presents, to the user, information (hereinafter, referred to as “use information”) as to whether or not the service of keeping the tire is possible. Specifically, for example, the “use information” includes information on whether the user can deliver the tires in a certain time zone of a certain base K or information on whether the user can pick up the tires in a certain time zone of a certain base K. The use information is generated by the server 1 based on vacancy information of each base K and each warehouse S per unit time (for example, one day) when the aforementioned optimum route is determined.

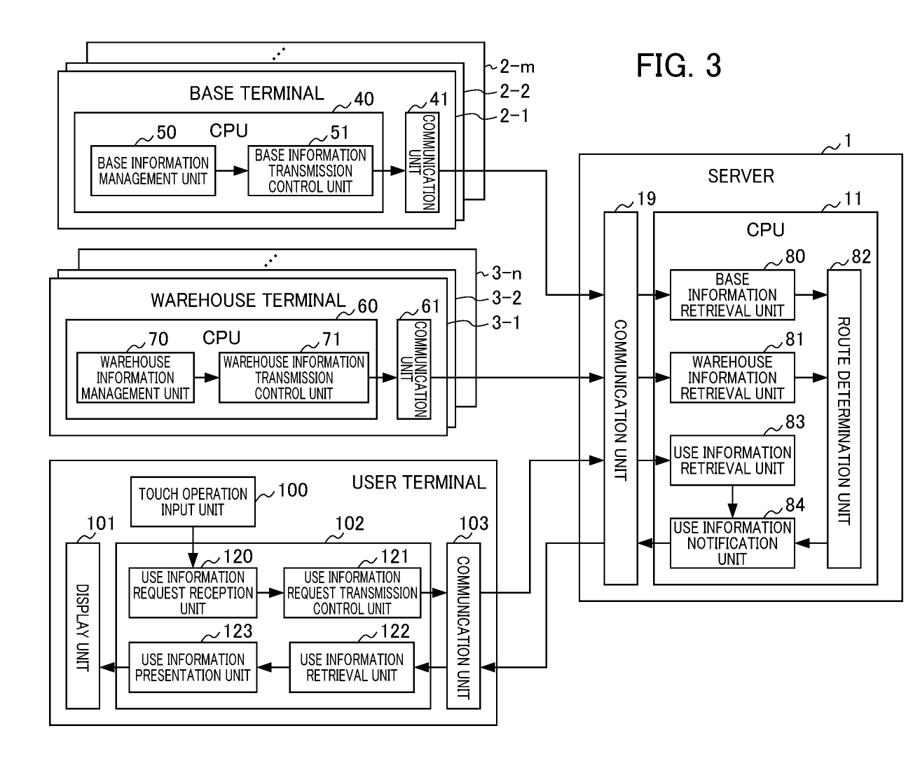

Such a series of processing is the route determination processing. In order to realize the route determination processing, the server 1, the base terminal 2, the warehouse terminal 3 and the user terminal 4 have functional configurations as illustrated in FIG. 3. FIG. 3 is a functional block diagram illustrating a functional configuration example of the server 1, the base terminal 2, the warehouse terminal 3 and the user terminal 4 of FIG. 2.

In a CPU 40 of the base terminal 2, a base information management unit 50 and a base information transmission control unit 51 function. In a CPU 60 of the warehouse terminal 3, a warehouse information management unit 70 and a warehouse information transmission control unit 71 function. In a CPU 11 of the server 1, a base information retrieval unit 80, a warehouse information retrieval unit 81, a route determination unit 82, a use information request retrieval unit 83, and a use information notification unit 84 function. In the CPU 102 of the user terminal 4, a use information request reception unit 120, a use information request transmission control unit 121, a use information retrieval unit 122, and a use information presentation unit 123 function.

The base information management unit 50 of a base terminal 2-K (K is an arbitrary integer value of 1 to m) retrieves and manages base information including amounts of the tires transferred to and from the base K-K per unit time (for example, one day). The base information transmission control unit 51 executes control for transmitting the base information managed by the base information management unit 50 to the server 1 via the communication unit 41 per unit time (for example, one day).

The warehouse information management unit 70 of a warehouse terminal 3-L (L is an arbitrary integer value among 1 to n) retrieves and manages warehouse information including vacancy situation for a warehouse S-L per unit time (for example, one day). The warehouse information transmission control unit 71 executes control for transmitting the base information retrieved by the warehouse information management unit 70 to the server 1 via a communication unit 61 per unit time (for example, one day).

The use information request reception unit 120 of the user terminal 4 receives a request for use information from the user via a touch operation input unit 100. The use information request transmission control unit 121 executes control for transmitting the use information request received by the use information request reception unit 120 to the server 1 via a communication unit 103. The server 1 transmits the use information determined based on the optimum route to the user terminal 4. Then, a use information retrieval unit 122 retrieves the use information transmitted from the server 1. Then, the use information presentation unit 123 controls the display unit 101 to display the use information retrieved by the use information retrieval unit 122, thereby presenting the use information to the user.

The base information retrieval unit 80 of the server 1 retrieves base information including amounts of the tires transferred to and from each of a plurality of bases K-1 to K-m for each of the bases per unit time (for example, one day). That is, each time base information is transmitted from a predetermined base terminal 2, the base information retrieval unit 80 retrieves the base information. In addition, the warehouse information retrieval unit 81 retrieves, for each of the plurality of warehouses S-1 to S-n, warehouse information including vacancy situation per predetermined unit time (for example, one day). That is, each time warehouse information is transmitted from a predetermined warehouse terminal 3, the warehouse information retrieval unit 81 retrieves the warehouse information.

The route determination unit 82 determines an optimum route as a route along which each of one or more trucks travels, based on base information for each of the plurality of bases K-1 to K-m and warehouse information for each of the plurality of warehouses S-1 to S-n per unit time (for example, one day). The route determination unit 82 also generates use information based on the optimum route.

The use information request retrieval unit 83 retrieves a request for use information transmitted from the user terminal 4. Then, when the use information request retrieval unit 83 retrieves the request for use information, the use information notification unit 84 notifies the use information generated by the route determination unit 82 via the communication unit 19 to the user terminal 4 having made the pertinent request.

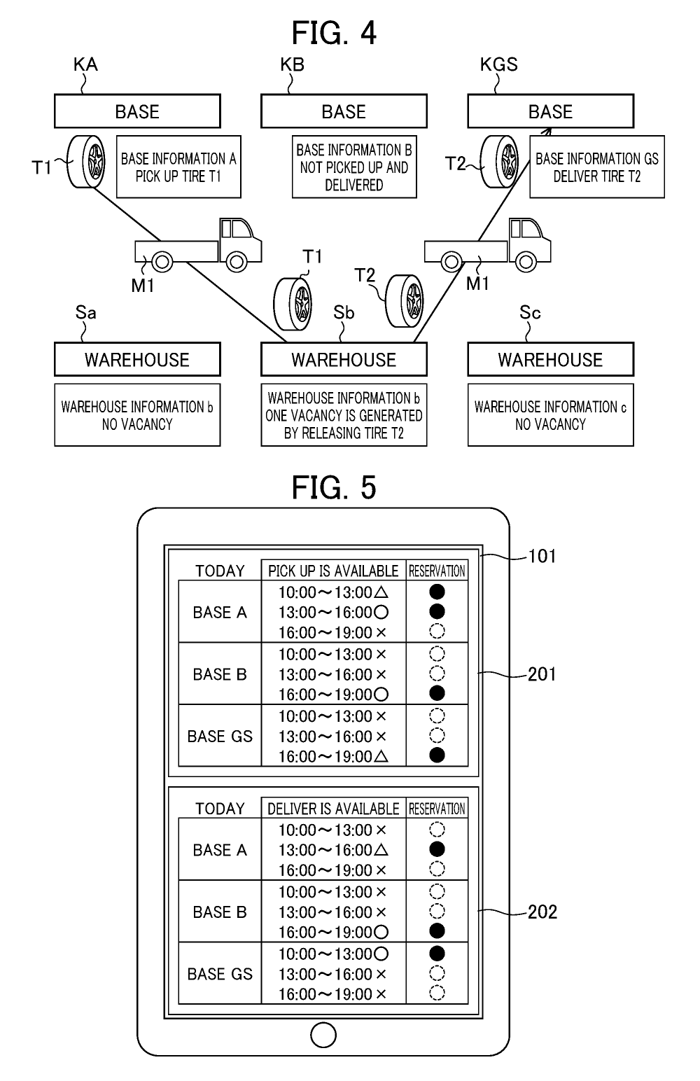

FIG. 4 is a diagram illustrating a specific example of the result of the route determination processing executed by the server 1 of FIG. 3. An example of FIG. 4 shows how to determine an optimum route in a predetermined range (for example, Yamanashi prefecture) including a dealer base KA, a dealer base KB, a gas station base KGS, a warehouse Sa, a warehouse Sb, and a warehouse Sc.

In the example of FIG. 4, the base terminal 2 of the base KA transmits, to the server 1, base information A indicating that the tire T1 is scheduled to be picked up in the subsequent unit time (for example, one day). The base terminal 2 of the base KB transmits, to the server 1, base information B indicating that the tire is not picked up and received in the subsequent unit time (for example, one day). The base terminal 2 of the base KC transmits, to the server 1, base information GS indicating that the tire T2 is scheduled to be delivered in the subsequent unit time (for example, one day). The base information retrieval unit 80 (FIG. 3) of the server 1 retrieves each of the base information A, B, and GS via the communication unit 19.

In the example of FIG. 4, the warehouse terminal 3 of the warehouse Sa transmits, to the server 1, warehouse information a indicating that there is no vacancy in the subsequent unit time (for example, one day). The warehouse terminal 3 of the warehouse Sb transmits, to the server 1, warehouse information b indicating that there is no vacancy in the subsequent unit time (for example, one day). The warehouse terminal 3 of the warehouse Sc transmits, to the server 1, base information GS indicating that the tire T2 is scheduled to be delivered in the subsequent unit time (for example, one day). The warehouse information retrieval unit 81 (FIG. 3) of the server 1 retrieves each of the warehouse information a, b and c via the communication unit 19.

The route determination unit 82 (FIG. 3) of the server 1 determines the route as illustrated in FIG. 4 as the optimum route of a truck M1 in the subsequent unit time (for example, one day) based on the base information A, B, GS and the warehouse information a, b, and c. That is, a route where the truck M1 first loads the tire T1 at the base KA, transports the tire to the warehouse Sb and unloads the tire, and then loads the tire T2 at the warehouse Sb and transports the tire to the base TKG and unloads the tire is determined as the optimum route.

Then, the route determination unit 82 determines use information as illustrated in FIG. 5 based on the optimum route determined in this manner. FIG. 5 is a diagram illustrating an example of a screen for presenting the use information, which is displayed on the user terminal of FIG. 3.

As illustrated in FIG. 5, the use information indicating whether it is possible to deliver the tire and whether it is possible to receive the tire at each base K for each time zone in the subsequent unit time (for example, today) is displayed on the display unit 101 of the user terminal 4 (FIG. 3), whereby the use information is presented to the user. Specifically, for example, on the screen 101 illustrating the use information in the example of FIG. 4, an area 201 indicating a time zone in which the user can receive the tire for each base K and an area 202 indicating a time zone in which the user can deliver the tire are displayed.

For example, the user can easily recognize visually that the tire can be delivered with sufficient time in the time zone from 13 o'clock to 16 o'clock at the base KA, and the tire can barely delivered in the time zone from 10 o'clock to 13 o'clock. Further, in the example of FIG. 4, the user can make a reservation for a tire by pressing a reservation button displayed on the right of the area 201 in a time zone in which the delivery can be performed.

Similarly, for example, the user can easily recognize visually that the tire can be barely received between 13 o'clock and 16 o'clock at the base KA, and the tire cannot be received in other time zones. Therefore, the user can make a reservation for the reception of the tire by pressing a reservation button displayed on the right in the time zone from 13 o'clock to 16 o'clock during which the reception is possible.

In this way, the user can easily and immediately know the base where the delivery is possible and the base where the reception is possible in a case where it is desired to deliver or receive the tire, and if necessary, the user can make a reservation of the delivery or reception on the spot.

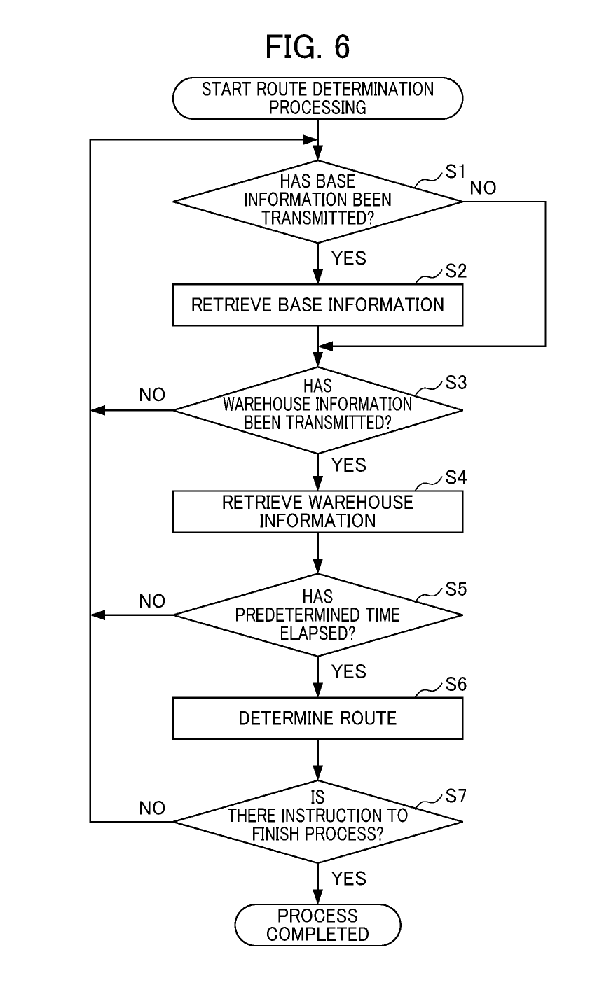

Next, with reference to FIG. 6, the route determination processing executed by the server 1 having the functional configuration of FIG. 3 will be described. FIG. 6 is a flowchart for describing a flow of the route determination processing executed by the server 1.

In step S1, the base information retrieval unit 80 determines whether base information has been transmitted. If no base information is transmitted from any one of the base terminals 2-1 to 2-m, it is determined as NO in step S1, and the process proceeds to step S3. On the other hand, if the base information is transmitted from the base terminal 2-K (K is an integer value of 1 to m), it is determined as YES in step S1, and the process proceeds to step S2. In step S2, the base information retrieval unit 80 retrieves base information from the base terminal 2-K.

In step S3, the warehouse information retrieval unit 81 determines whether warehouse information has been transmitted. If no warehouse information is transmitted from any one of the warehouse terminals 3-1 to 3-n, it is determined as NO in step S3, and the process returns to step S1. On the other hand, if the warehouse information has been transmitted from the warehouse terminal 3-L (L is an integer value of 1 to n), it is determined as YES in step S3, and the process proceeds to step S4. In step S4, the warehouse information retrieval unit 81 retrieves warehouse information from the warehouse terminal 3-L.

In step S5, the route determination unit 82 determines whether a predetermined time (for example, a unit time such as one day) has elapsed. If the predetermined time has not elapsed, it is determined as NO in step S5, and the process returns to step S1. That is, a loop process of steps S1 to S5 is repeated until the predetermined time elapses, the base information is obtained from each base K and warehouse information is obtained from each warehouse S. When the predetermined time has elapsed, it is determined as YES in step S5, and the process proceeds to step S6.

In step S6, the route determination unit 82 determines the optimum route of the truck for transporting the tire from the base information retrieved in step S2 and the warehouse information retrieved in step S4 in step S2 and step S4.

Although embodiment of the present invention has been described hereinbefore, the present invention is not limited to embodiment mentioned above. Further, effects described in the present embodiment are only listing of the most preferable effects generated from the present invention, and the effects of the present invention are not limited to those described in the present embodiment.

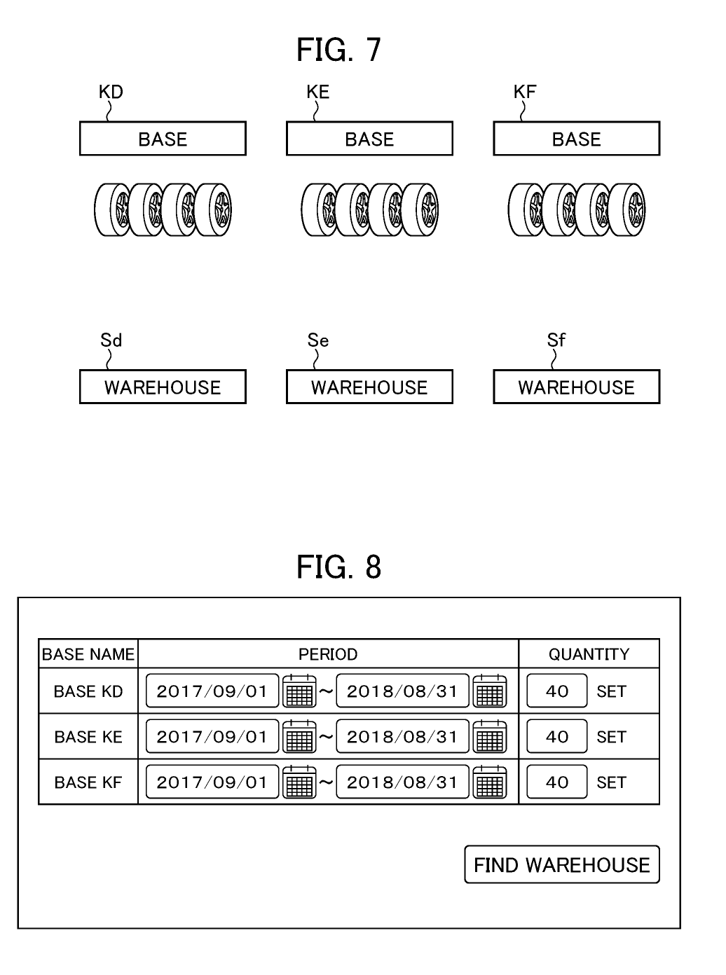

For example, the route determination method relating to the aforementioned route determination processing is not particularly limited to the aforementioned embodiment. Therefore, hereinafter, a method different from the method exemplified in the above embodiments will be described with reference to FIGS. 7 to 11.

However, in order to clarify a difference from the method illustrated in the aforementioned embodiments, the number of bases and the number of warehouses are matched respectively as illustrated in FIG. 7, and the following description is given. FIG. 7 illustrates an application example of the route determination processing executed by the server of FIG. 3, and is a diagram illustrating an example different from the example of FIG. 4. In the example of FIG. 7, in order to determine an optimum route in a predetermined range (for example, Yamanashi prefecture) including a dealer base KD, a dealer base KE, a gas station base KF, a warehouse Sd, a warehouse Se and a warehouse Sf, a route determination processing is applied. The route determination processing described in the example of FIG. 7 will be, hereinafter, particularly referred to as a “tire deposit route determination processing” in order to distinguish it from the aforementioned processing. Further, like the other examples mentioned above. Hereinafter, in a case where it is not necessary to individually distinguish each of the base KD, the base KE, and the base KF, these are collectively referred to as a “base K”, and in a case where it is not necessary to individually distinguish each of the warehouse Sd, the warehouse Se, and the warehouse Sf, these are collectively referred to as a “warehouse S”.

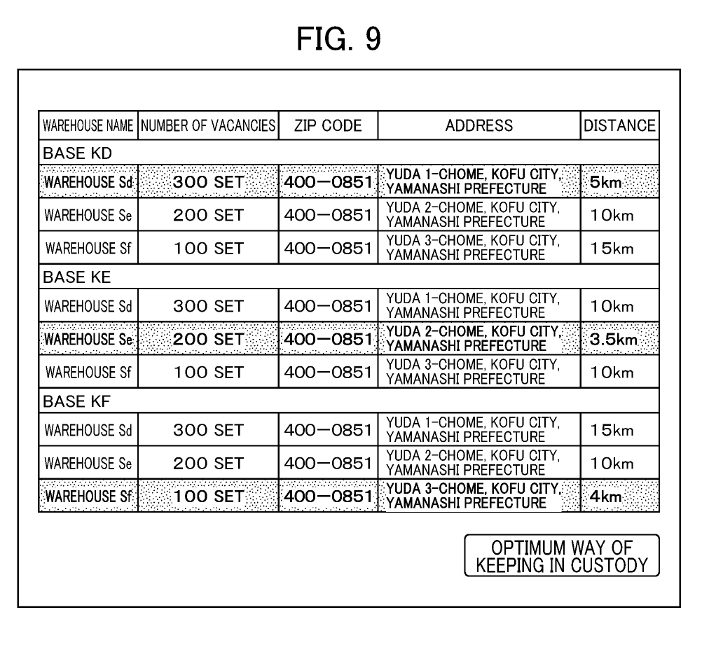

FIG. 8 is a view illustrating an example of an image in which base information of each base K is displayed within a predetermined period in the tire deposit route determination processing executed by the server 1 of FIG. 3. In the example of FIG. 8, information on a “base name”, a “period”, and a “quantity” is displayed for each base K as the base information. Specifically, one predetermined row corresponds to the base information of one predetermined base K. That is, in an item of “base name”, a name of the base K corresponding to the pertinent row is displayed. For example, “base KD” is displayed in the first column of “base name”. That is, the pertinent row is the base information of “base KD”. In the item of “period”, a period of storage (generally storage in the warehouse S) of the tire kept at each base K is displayed. For example, in the first column of “period”, “2017/09/01 to 2018/08/31” is displayed. That is, it indicates that the storage period of the tire kept at the base KD in the warehouse S is “2017/09/01 to 2018/08/31”. In an item of “quantity,” a quantity of tires kept at each base K is displayed. In the first column of “quantity”, “40 sets” is displayed. That is, it indicates that the quantity of tires kept at the base KD is “40 sets”. When matched to the aforementioned example of FIG. 6, the process result of step S2 is displayed on the image of FIG. 8. Therefore, when a person who desires to determine the route (for example, a service provider who manages the server 1) clicks (pushes down) a software button “find a warehouse” present in the lower right of FIG. 8 with a mouse (input unit 16), step S4 is executed to retrieve the warehouse information, and the image illustrated in FIG. 9 is displayed.

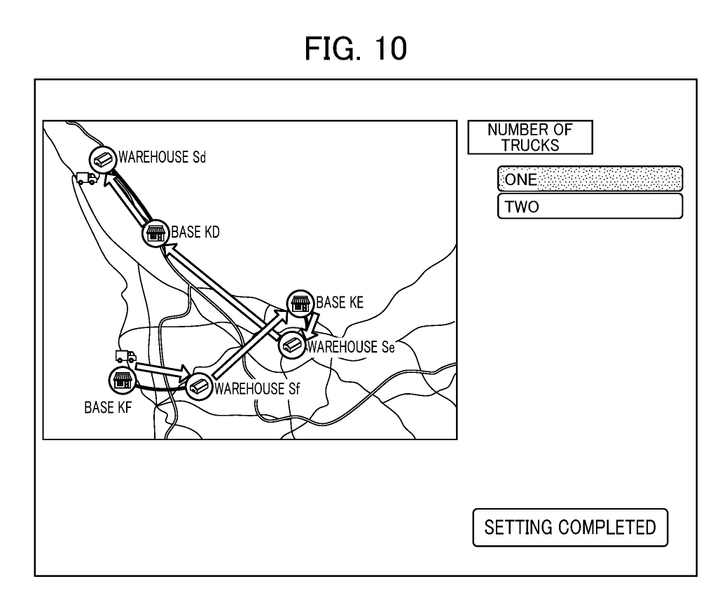

FIG. 9 is a diagram illustrating an example of a warehouse list used at the time of route determination in the tire deposit route determination processing executed by the server 1 of FIG. 3. In an example of FIG. 9, information on “warehouse name”, “the number of vacancies”, “zip code”, “address” and “distance” is displayed as information on the warehouse S for each of the bases K. That is, based on the base information of FIG. 8, an example of a list of various information regarding one or more warehouses S that may be the storage destination is the warehouse list illustrated in FIG. 9. That is, the process result of step S4 of FIG. 6 is displayed as a warehouse list. Specifically, one predetermined row corresponds to warehouse information of one predetermined warehouse S. Then, for each base K, warehouse information on each of one or more warehouses S that are candidates for storage destinations is displayed. That is, the candidate of the storage destination of the tire kept at the base KD is the warehouse Sd, the warehouse Se, and the warehouse Sf. In the item of “warehouse name”, the name of the warehouse S corresponding to the pertinent row is displayed. In the first column of “warehouse name” of the base KD, “warehouse Sd” is displayed. That is, it is understood that one of the candidates for the tire storage destination viewed from the base KD is the “warehouse Sd” in the pertinent row. In the item of “the number of vacancies”, the number of tires that can be stored (the number of vacancies) in the period illustrated in FIG. 8 is displayed in the warehouse S corresponding to the pertinent row. One row of the warehouse Sd of the base KD displays “300 sets”. That is, it is understood that the number of tires (the number of vacancies) which can be stored in the warehouse Sd in the period of 2017/09/01 to 2018/08/31 among the tires kept at the base KD is “300 sets”. In the item of “zip code”, the zip code of the warehouse S corresponding to the pertinent row is displayed. One row of the warehouse Sd of the base KD displays “400-0851”. That is, it is understood that the zip code of the warehouse Sd is “400-0851”. In the item of “address”, the address of the warehouse S corresponding to the pertinent row is displayed. In one row of the warehouse Sd of the base KD, “Yuda 1-chome, Kofu City, Yamanashi Prefecture” is displayed. That is, it is understood that the address of the warehouse Sd is “Yuda 1-chome, Kofu City, Yamanashi Prefecture”. In the item of “distance”, the distance from the base K to the warehouse S corresponding to the pertinent row is displayed. One row of the warehouse Sd of the base KD displays “5 km”. That is, it is understood that the distance between the base KD and the warehouse Sd is “5 km”. As described above, when matched to the example of FIG. 6, the processing result of step S4 is displayed in the image of FIG. 8. Therefore, when a person who desires to determine the route (for example, a service provider who manages the server 1) clicks (pushes down) a software button “optimum method of keeping” present in the lower right of FIG. 9 with the mouse (input unit 16), the process of step S6 is executed, and an optimum route is determined as a route for transporting the tire from each base K to the optimum one or more warehouses S. A specific example of the optimum route will be described with reference to FIG. 10 and subsequent drawings.

FIG. 10 is a diagram illustrating an example of a result when the number of trucks is one in the tire deposit route determination processing executed by the server 1 of FIG. 3. Specifically, FIG. 10 illustrates an example of determining an optimum route in a case where one truck transports the tires deposited from each base K (base KD, base KE, and base KF) to each target warehouse S (the warehouse Sd, the warehouse Se, and the warehouse Sf). That is, in the example of FIG. 10, a route in which one truck travels from the base KF to the warehouse Sf, to the base KE, to the warehouse Se, to a base KD, and to a warehouse Sd is displayed as an optimum route. That is, it is illustrated that the optimum route for tire deposit based on the conditions set in FIG. 9 and the like is the route travelling from the base KF to the warehouse Sf, to the base KE, to the warehouse Se, to the base KD, and to the warehouse Sd.

Specifically, for example, according to the method of determining the optimum route of this example, the warehouse S having the shortest distance is first determined as the storage destination of the tires for each of the bases K. That is, as illustrated in FIG. 9, respective routes from the base KD to the warehouse Sd, to the base KE, to the warehouse Se, and from the base KF to the warehouse Sf (these routes will be hereinafter referred to as “unit route”) are determined. Next, based on a positional relationship of these unit routes, an order of the unit routes is determined. In this example, as illustrated in FIG. 10, first, the unit route from the base KF to the warehouse Sf is determined, secondly, the unit route from the base KE to the warehouse Se is determined, and thirdly, the unit route from the base KD to the warehouse Sd is determined. Then, these unit routes are connected in the determined order, whereby the optimum route is determined. That is, in this example, as described above, a route in which one truck travels from the base KF to the warehouse Sf, to the base KE, to the warehouse Se, to the base KD, and to the warehouse Sd is determined as the optimum route.

If there is no problem with the route determined in this way, the person who desires to determine the route (for example, the service provider who manages the server 1) clicks (pushes down) a software button “setting completed” present in the lower right of FIG. 10 with the mouse (the input unit 16). Then, the tire deposit route determination processing is finished, and an actual route is determined.

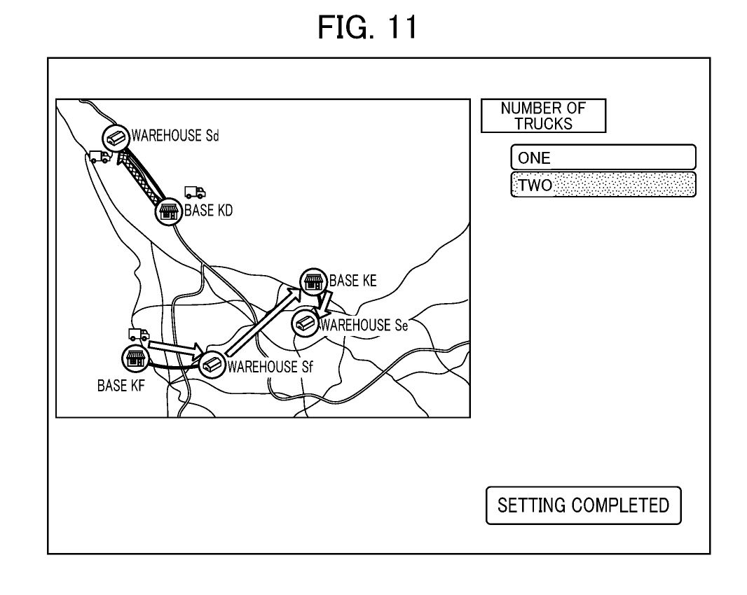

Further, as illustrated in FIG. 11, the method of determining the optimum route for tire deposit of this example can be applied to a case where there are a plurality of trucks. FIG. 11 is a diagram illustrating an example of the result in a case where there are two trucks in the tire deposit route determination processing executed by the server of FIG. 3.

Specifically, FIG. 11 illustrates an example of determining an optimum route in a case where two trucks transport the tires deposited from each base K (the base KD, the base KE, and the base KF) to each target warehouse S (the warehouse Sd, the warehouse Se, and the warehouse Sf). Specifically, FIG. 11 illustrates an example of determining an optimum route in a case where two trucks transport the tires deposited from each base K (the base KD, the base KE, the base KF) to each target warehouses S (the warehouse Sd, the warehouse Se, and the warehouse Sf). That is, in the example of FIG. 11, a route in which one of the two trucks travels in a route from the base KF to the warehouse Sf, to the base KE, and to the warehouse Se is indicated. In addition, a route is indicated in which the other of two trucks travels from the base KD to the warehouse Sd. That is, on the basis of the condition set in FIG. 9 and the like, the optimum route for tire deposit is a route where one truck travels from the base KF to the warehouse Sf, to the base KE, and to the warehouse Se, and the other truck travels from the base KD to the warehouse Sd.

First, unit routes from the respective bases K to the warehouses S are respectively determined in the same manner as the case of one truck illustrated in FIG. 10. Next, it is determined which truck is in charge of which unit route. In the example of FIG. 11, a unit route from the base KF to the warehouse Sf and a unit route from the base KE to the warehouse Se are determined as the charge of the first truck. On the other hand, a unit route from the base KD to the warehouse Sd is determined as the charge of the second truck. Then, based on positional relationships of these unit routes, an order of the unit routes is determined for each truck. In this example, as illustrated in FIG. 11, for the first truck, the unit route from the base KF to the warehouse Sf is determined first, and the unit route from the base KE to the warehouse Se is determined second. On the other hand, for the second truck, the unit route from the base KD to the warehouse Sd is determined first. Then, these unit routes are connected in the determined order for each truck, whereby the optimum route is determined. That is, in this example, as described above, a route where the first truck travels from the base KF to the warehouse Sf, to the base KE, and to the warehouse Se while the second truck travels from the base KD to the warehouse Sd is determined as the optimum route.

If there is no problem with the route determined in this way, a person who desires to determine the route (for example, a service provider who manages the server 1) clicks (pushes down) a software button “setting completed” present in the lower right of FIG. 10 with the mouse (input unit 16). Then, the tire deposit route determination processing is finished, and the actual route is determined.

Although the above embodiments have been described using the tire as goods and the truck as a mobile entity for transporting the goods, these are only examples for description and are not particularly limited thereto. For example, the goods delivered by the user may be any goods such as ornament or furniture within a scope for achieving the purpose of the invention. Further, for example, any transport vehicle such as a bike or a passenger car may be used as the mobile entity for transporting the goods. That is, the provider of this service may adopt not only the truck but also other mobile entities, that is, mobile entities including airplanes, ships and the like, and may determine an optimum route including not only land routes but also air routes and sea routes. Further, the provider of this service can determine the optimum route for any mobile entity, regardless of business use or home use.

Further, in the aforementioned embodiments, the method of determining the route by the route determination unit 82 and the method of determining the use information are not particularly defined, but any method may be used. That is, any means or algorithm may be used within a scope of achieving the purpose of the present invention.

Further, in the aforementioned embodiments, although the optimum route is determined in consideration of only base information and warehouse information, a movement distance of the mobile entity may be further considered. That is, the route determination unit 82 may determine routes along which each of one or more mobile entities travels, based on a distance between each of the plurality of bases and each of the plurality of warehouses. This makes it possible to more accurately determine the optimum route of the mobile entity and the use information of the user.

Further, in the aforementioned embodiments, the optimum route is determined without considering the information of season or weather, but the information of season or weather may be further considered. This makes it possible to more accurately determine the optimum route of the mobile entity and the use information of the user.

In the aforementioned embodiments, the optimum route is determined without considering information on retrieval availability or information on a form of rental (a rent and the like) of the mobile entity to be used, but information on retrieval availability or information on a form of rental (a rent and the like) of the mobile entity to be used may be further considered. This makes it possible to determine the optimum route of the mobile entity and the use information of the user more practically.

Further, in the aforementioned embodiments, the optimum route is determined without considering information on the number of the mobile entities and a capacity thereof to be used, but the information on the number or capacity of mobile entity to be used may be further considered. This makes it possible to more accurately determine the optimum route of the mobile entity and the use information of the user.

Further, in the aforementioned embodiments (especially FIG. 8), although the “base name”, the “period”, and the “quantity” are adopted as the base information, the base information is not specifically limited thereto. For example, various conditions such as types of goods to be kept may be adopted as a part of the base information.

Further, in the aforementioned embodiments (especially, FIG. 9), information of “warehouse name”, “the number of vacancies”, “zip code”, “address” and “distance” is adopted as the warehouse information, but the warehouse information is not limited thereto. For example, various conditions such as whether temperature control of the warehouse S can be performed, physical distribution delivery date, physical distribution cost, and past performance (claims) may be adopted as a part of the base information.

Further, in the aforementioned embodiments (especially FIG. 10 and FIG. 11), when determining the optimum route of the optimum tire deposit, one or two trucks are adopted and the optimum route is determined, but the determination of the optimum route is not limited thereto. That is, the provider of the service may adopt an arbitrary number of trucks to determine the optimum route. Further, the provider of the service may adopt a truck with any attribute to determine the optimum route. Here, as a type of attribute, it is possible to adopt loading weight (4t car and the like), whether or not the truck is owned by the provider of the service (in-house) or whether or not the truck is owned by another company (registered in this service).

Further, in the aforementioned embodiments, although the information processing device of the present invention includes the server 1, the base terminal 2, the warehouse terminal 3, and the user terminal 4, but it is only an illustration for achieving the purpose of the present invention, and is not particularly limited. For example, a terminal possessed by a driver of a mobile entity may be added as a mobile entity terminal to the configuration of the present invention.

Further, each hardware configuration illustrated in FIG. 2 is merely an example for achieving the purpose of the present invention, and is not particularly limited.

Further, the functional block diagram illustrated in FIG. 3 is merely an example and is not particularly limited. That is, it is sufficient if the information processing device has functions capable of executing the aforementioned series of processes as a whole, and what functional blocks are used to realize those functions is not particularly limited to the example of FIG. 3.

Further, locations of the functional blocks are not limited to those in FIG. 3 and may be arbitrary. For example, at least a part of the functional blocks on the side of the server 1 may be provided on one of the base terminal 2, the warehouse terminal 3, and the user terminal 4, or vice versa. One functional block may be configured as a single piece of hardware or in combination with a single piece of software.

Further, although the base terminal 2, the warehouse terminal 3, and the user terminal 4 are configured by smart phones in the aforementioned embodiments, the terminals may be configured not only by the smart phone but also by arbitrary apparatuses including a tablet and a new device in the future.

In a case where processing of each functional block is executed by a software, a program constituting the software is installed on a computer or the like from a network or a recording medium. The computer may be a computer incorporated in dedicated hardware. Further, the computer may be a computer capable of executing various functions by installing various programs, for example, a general-purpose smartphone or personal computer other than a server.

A recording medium including such a program is not only configured by removable media distributed separately from a device main body to provide the program to each user, but is also configured by recording medium and the like provided to each user in a state of being incorporated in the device main body in advance.

In the present specification, a step of describing the program to be recorded on the recording medium includes not only, as a matter of course, a processing executed chronologically according to its order but also a processing executed in parallel or individually although not necessarily in chronological order.

In summary, the information processing device to which the present invention is applied is sufficient if the present invention has the following configuration, and various embodiments may be taken. That is, it is sufficient if the information processing device to which the present invention is applied is

an information processing device, which makes a schedule of mobile entities that transport one or more goods via a route including at least one base and one warehouse among a plurality of bases for picking up the goods from a user or delivering the goods to the user and a plurality of warehouses for storing the goods, and the information processing device includes:
a base information retrieval means (for example, the base information management unit 50 in FIG. 3) that retrieves base information including amounts of goods transferred to and from each of the plurality of bases per predetermined unit time; a warehouse information retrieval means (for example, the warehouse information management unit 70 in FIG. 3) that retrieves warehouse information including vacancy situation for each of the plurality of warehouses per predetermined unit time; and
a route determination means (for example, the route determination unit 82 of FIG. 3) that determines a route along which each of one or more of the mobile entities travels based on the base information of each of the plurality of bases and the warehouse information of each of the plurality of warehouses. Such an information processing device is applied, whereby, in a service or the like of keeping goods, it is possible to provide a feature with which the optimum route of a mobile entity can be successively determined and, as a result thereof, a service or the like of keeping goods from a user can be effectively operated.

### EXPLANATION OF REFERENCE NUMERALS

1: SERVER, 2, 2-1 to 2-m: BASE TERMINAL, 3, 3-1 to 3-n: WAREHOUSE TERMINAL, 4, 4-1 to 4-p: USER TERMINAL, 11: CPU, 40: CPU, 50: BASE INFORMATION MANAGEMENT UNIT, 51: BASE INFORMATION TRANSMISSION CONTROL UNIT, 60: CPU, 70: WAREHOUSE INFORMATION MANAGEMENT UNIT, 71: WAREHOUSE INFORMATION TRANSMISSION CONTROL UNIT, 80: BASE INFORMATION RETRIEVAL UNIT, 81: WAREHOUSE INFORMATION RETRIEVAL UNIT, 82: ROUTE DETERMINATION UNIT, 83: USE INFORMATION REQUEST RETRIEVAL UNIT, 84: USE INFORMATION NOTIFICATION UNIT, 102: CPU, 120: USE INFORMATION REQUEST RECEPTION UNIT, 121: USE INFORMATION REQUEST TRANSMISSION CONTROL UNIT, 122: USE INFORMATION RETRIEVAL UNIT, 123: USE INFORMATION PRESENTATION UNIT

1. An information processing device, which makes a schedule of mobile entities that transport one or more goods via a route including at least one base and one warehouse among a plurality of bases for picking up the goods from a user or delivering the goods to the user and a plurality of warehouses for storing the goods, the information processing device comprising:
a base information retrieval means that retrieves base information including amounts of goods transferred to and from each of the plurality of bases per predetermined unit time;
a warehouse information retrieval means that retrieves warehouse information including vacancy situation for each of the plurality of warehouses per predetermined unit time; and
a route determination means that determines a route along which each of one or more of the mobile entities travels based on the base information of each of the plurality of bases and the warehouse information of each of the plurality of warehouses.

2. The information processing device according to claim 1, wherein the route determination means
has a function of determining a route along which each of one or more of the mobile entities travels, based on a distance between each of the plurality of bases and each of the plurality of warehouses.

3. The information processing device according to claim 1, wherein the route determination means
further has a function of determining a route along which each of one or more of the mobile entities travels based on a season.

4. The information processing device according to claim 1, wherein the route determination means further has a function of determining a route along which each of one or more of the mobile entities travels based on a form of retrieval or rental of the mobile entities.

5. The information processing device according to claim 1, wherein the route determination means
further has a function of determining a route along which each of one or more of the mobile entities travel based on the number of the mobile entities and a capacity thereof.

6. The information processing device according to claim 1, wherein the user is capable of setting the base for delivering the goods and the base for receiving the goods independently of each other among the plurality of bases, and
the information processing device further comprises a presentation means that presents the user with information on the base where it is still possible to pick up or deliver the goods after the route is determined by the route determination means.
